(19) United States
(12) Patent Application Publication
(10) Pub. No.: US 2018/0374123 A1
(43) Pub. Date: Dec. 27, 2018

(54) ADVERTISEMENT PUSH SYSTEM, SERVER AND ELECTRONIC DEVICE USING THE SAME

(71) Applicant: ASUSTEK COMPUTER INC., Taipei (TW)

(72) Inventors: Yen-Chun LEE, Taipei (TW); Ruo-Ling LIU, Taipei (TW)

(21) Appl. No.: 16/013,367

(22) Filed: Jun. 20, 2018

(30) Foreign Application Priority Data
Jun. 21, 2017 (CN) 201710474685.7

(51) Int. Cl. G06Q 30/02; H04W 4/021; H04W 4/02; G06F 17/30

(52) U.S. Cl. CPC G06Q 30/0261; H04W 4/021; G06Q 30/0269; G06F 17/30241; H04W 4/026

(57) ABSTRACT

The disclosure discloses a processor. The processor is applied to an advertisement push system. The processor is configured to executes steps of: receiving a device location coordinate of an electronic device; and outputting advertisement information regarding to an advertisement push region corresponding to the device location coordinate to the electronic device when the device location coordinate is determined to be located in at least one of the advertisement push regions.

### CROSS-REFERENCE TO RELATED APPLICATION

This application claims the priority benefit of CN application serial No. 201710474685.7, filed on Jun. 21, 2017. The entirety of the above-mentioned patent application is hereby incorporated by references herein and made a part of specification.

### BACKGROUND OF THE INVENTION

### Field of the Invention

The disclosure relates to an advertisement push system.

### Description of the Related Art

Recently, various application programs are provided at a smart electronic device to satisfy different requirements from users. Most free application programs are configured with advertisement to gain revenue.

In general, an advertisement are broadcasted at the application program via a banner, an interstitial advertisement, or an interactive manner of questioning and answering options, a simple game or a broadcast of image video.

### BRIEF SUMMARY OF THE INVENTION

According to a first aspect, an advertisement push system is provided. The advertisement push system comprises: receiving a device location coordinate of an electronic device; and outputting advertisement information regarding to at least one of advertisement push regions corresponding to the device location coordinate to the electronic device when the device location coordinate is determined to be located in the advertisement push region.

According to a second aspect, a server conducted to an advertisement push system is provided. The server comprises: an advertisement push database configured to store a plurality of push locations, advertisement push regions corresponding to each push location and advertisement information to be pushed according to the advertisement push regions; and a processor connected with the advertisement push database; wherein the server outputs advertisement information regarding to one of the advertisement push regions corresponding to a device location coordinate when the server receives the device location coordinate from the electronic device and the processor determines that the device location coordinate is located in the advertisement push region.

According to a third aspect, an electronic device is provided. The electronic device is applied to an advertisement push system with a server, the electronic device comprises: a positioning module configured to position a location of the electronic device to generate a device location coordinate; a second processor connected with the positioning module, the second processor is configured to receive the device location coordinate; a transmission module connected to the second processor, the transmission module is configured to output the device location coordinate; an image capturing module connected with the processor, the image capturing module is configured to capture a real-time image; and a display connected to the second processor; wherein after the transmission module outputs the device location coordinate to the server, the electronic device receives the advertisement information regarding to the device location coordinate from the server.

A device location coordinate is generated by positioning the mobile device via a positioning module. An expanding reality information is generated by combining the advertisement information regarding to the device location coordinate and the real-time reality image, and the expanding reality information is displayed via the display. Then, a pushing of the advertisement is performed via an interactive display of the advertisement information. As a result, user convenience is improved and an interaction between the user and the advertisement content is enhanced.

### BRIEF DESCRIPTION OF THE DRAWINGS

FIG. 1 is a schematic diagram showing an advertisement push system in an embodiment;

FIG. 2 is a schematic diagram showing an advertisement push system of which a push location and an advertisement push region are shown in a map data according to an embodiment;

FIG. 3 is a schematic diagram showing a plurality of advertisement information are shown on a display in an advertisement push system in an embodiment;

FIG. 4 is a schematic diagram showing a selected advertisement information and a real-time reality image in an advertisement push system are combined to an expanding reality information in an embodiment; and

FIG. 5 is a schematic diagram showing a push location and an advertisement push region are displayed in a map data in an advertisement push system in an embodiment.

### DETAILED DESCRIPTION OF THE EMBODIMENTS

These and other features, aspects, and advantages of the disclosure will become better understood with regard to the following description, appended claims, and accompanying drawings. The components shown in figures are not used to limit the size or the proportion.

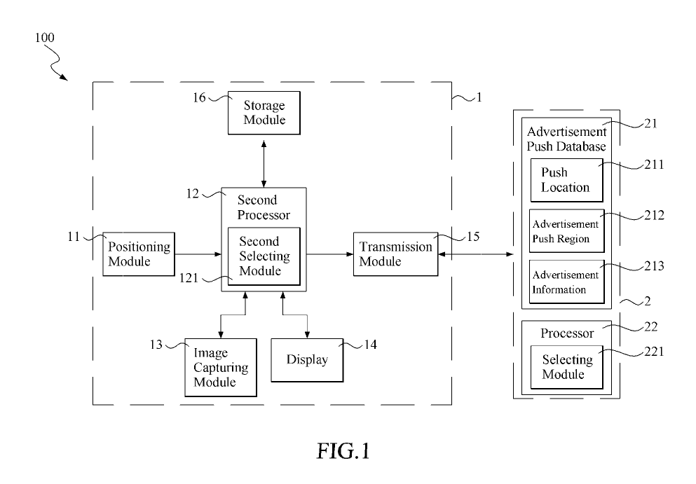

Please refer to FIG. 1, in an embodiment, an advertisement push system 100 includes an electronic device 1 and a server 2.

The electronic device 1 includes a positioning module 11, a second processor 12, an image capturing module 13, a display 14, a transmission module 15 and a storage module 16. In an embodiment, the electronic device 1 is a smart electronic device, such as a smart phone and a tablet computer. The positioning module 11 is configured to position a location of the electronic device 1 to generate a device location coordinate. The positioning module 11 is a global positioning system (GPS), a base station positioning technology, or a Wi-Fi positioning technology. In an embodiment, the device location coordinate is a latitude and longitude.

In an embodiment, the second processor 12 is connected with the positioning module 11. The second processor 12 is configured to receive the device location coordinate. The image capturing module 13 is connected with the second processor 12 and configured to capture a real-time reality image. The display 14 is connected to the second processor 12 and configured to display the real-time reality image. In an embodiment, the image capturing module 13 is a charge-coupled device (CCD). The display 14 is a touch screen. The transmission module 15 is connected to the second processor 12. The transmission module 15 is configured to be communicated to the server 2. Moreover, in an embodiment, the transmission module 15 has a wireless communication transmission by using a wireless transmission technology, such as a 3G/4G/5G mobile communication system or Wi-Fi.

In an embodiment, the server 2 includes an advertisement push database 21 and a processor 22. The advertisement push database 21 is configured to store a plurality of push locations 211 (only one is shown in figure), advertisement push regions 212 corresponding to each push location 211, and advertisement information 213 regarding to the advertisement push regions 212 (that is, advertisement information 213 to be pushed in a specific advertisement push region 212) In other embodiment, The advertisement push database 21 is further configured to store selecting conditions. In an embodiment, the push location 211 is a location of a coffee house. The advertisement push region 212 is a region of 200 meters around the coffee house. The advertisement information 213 is half-price coffee discount information, which is not limited herein.

In an embodiment, when the processor 22 of the server 2 receives the device location coordinate of the electronic device 1 and determines that the device location coordinate is at one of the advertisement push regions 212, the server 2 outputs advertisement information 213 regarding to the advertisement push region 212 (that is, advertisement information 213 to be pushed in the advertisement push region 212) corresponding to the device location coordinate to the electronic device 1. Then, the second processor 12 of the electronic device 1 combines the received advertisement information 213 and a real-time reality image=to output an expanding reality information. Then, the expanding reality information is displayed via the display 14.

In an embodiment, the advertisement information 213 is media data, such as image, audio or video. The image information is a moving image, a static image, a frame, a background or a filter with advertisement information, promotion news or corporate campaign. The audio is an advertising word, a phrase or a slogan of an advertisement or promotion news. In an embodiment, the video is an advertising film.

In an embodiment, the second processor 12 of the electronic device 1 receives the device location coordinate from the positioning module 11. The electronic device 1 receives the advertisement information 213 regarding to the advertisement push region 212 corresponding to the location coordinate is from the server 2 after outputting the device location coordinate to the server 2 via the transmission module 15. In an embodiment, the second processor 12 includes a second selecting module 121. The second selecting module 121 includes at least one selecting setting. In an embodiment, when the electronic device 1 receives the advertisement information 213 regarding to the advertisement push region corresponding to the device location coordinate from the server 2, the second selecting module 121 determines whether the advertisement information 213 is displayed on the display 14 according to the selecting setting. In an embodiment, the user can select advertisement categories options of a menu to receive or to reject the advertisement belonging to the selected advertisement categories to complete the selecting setting. In an embodiment, when the selecting setting is that a clothing advertisement category option is closed, the advertisement information related to the clothing advertisement category is rejected to be displayed on the display 14 via the second selecting module 121. In an embodiment, the storage module 16 is connected with the second processor 12. The storage module 16 is configured to store the selecting settings.

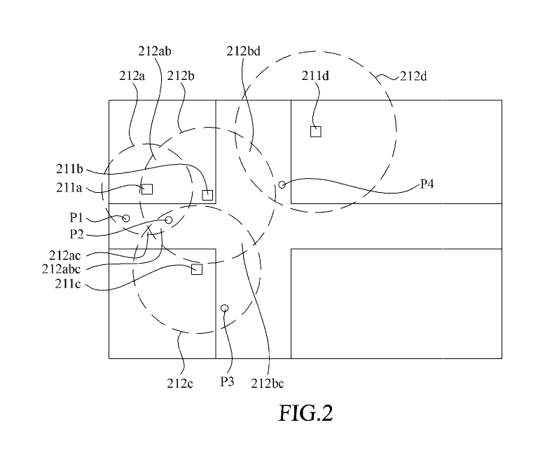

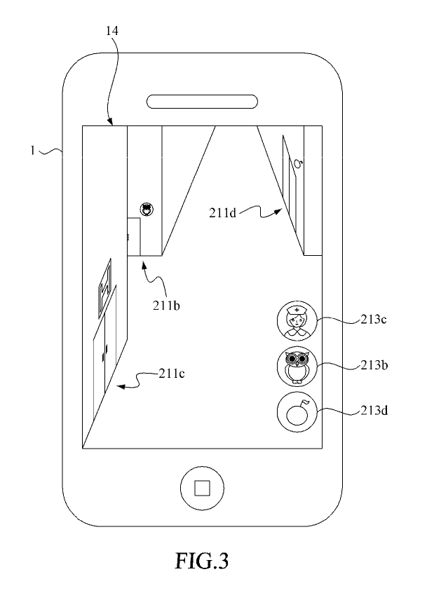

Please refer to FIG. 2 and FIG. 3, in an embodiment, push locations 211a, 211b, 211c and 211d are located in a same area. Each push location 211a, 211b, 211c and 211d is covered by the advertisement push region 212a, 212b, 212c and 212d, respectively. In an embodiment, when the processor 22 determines that the device location coordinate P1 of the electronic device 1 is in the advertisement push region 212a, the advertisement information 213a regarding to the advertisement push region 212a is output to the electronic device 1 by the server 2. When the processor 22 determines that the device location coordinate P3 of the electronic device 1 is located in the advertisement push region 212c, the advertisement information 213c regarding to the advertisement push region 212c is output to the electronic device 1 by the server 2.

In one embodiment, the advertisement push regions 212a, 212b, 212c and 212d overlap with each other. The overlapping area between the advertisement push regions 212a and 212b is defined as overlapping region 212ab, the overlapping area between the advertisement push regions 212b and 212c is defined as overlapping region 212bc, the overlapping area between the advertisement push regions 212a and 212c is defined as overlapping region 212ac, the overlapping area between the advertisement push regions 212b and 212d is defined as overlapping region 212bd, and the overlapping area among the advertisement push regions 212a, 212b and 212c is defined as overlapping region 212abc. In an embodiment, when the processor 22 determines that the device location coordinate P2 of the electronic device 1 is in the overlapping region 212abc, the advertisement information 213a, 213b, 213c regarding to the overlapping region 212abc is output to the electronic device 1 by the server 2. In an embodiment, the advertisement information regarding to the overlapping region 212abc includes the advertisement information 213a regarding to the advertisement push region 212a, the advertisement information 213b regarding to the advertisement push region 212b, and the advertisement information 213c corresponding to the advertisement push region 212c, which is not limited herein.

Please refer to FIG. 2, in an embodiment, the processor 22 further includes a selecting module 221. When the device location coordinate P2 of the electronic device 1 is located in the overlapping region 212abc, the advertisement information 213 to be pushed in the overlapping region 212abc includes the advertisement information 213a corresponding to the advertisement push region 212a, the advertisement information 213b regarding to the advertisement push region 212b and the advertisement information 213c regarding to the advertisement push region 212c. Before the advertisement information 213a, 213b, 213c regarding to the overlapping region 212abc is output to the electronic device 1 by the server 2, the advertisement information 213b matching to a gender of a user is selected from the advertisement information 213 to be pushed in the overlapping region 212abc as a target advertisement information by the selecting module 221 according to at least one selecting condition received from the advertisement push database 21 (For example, the selecting condition is that the user is male.) Then, the target advertisement information is output to the electronic device 1. The received target advertisement information is combined with a real-time reality image via the second processor 12 to output expanding reality information. Then, the expanding reality information is displayed at the display 14.

In an embodiment, the selecting condition includes user information. The user information includes personal basic data, consumer habit information, activity information or preference information, which is not limited herein.

In an embodiment, the personal basic data is gender, age, constellation, height or weight. The consumer habit information includes a store, a brand that the user often consumes or follows, a travel habit of the user or a brand loyalty of the user. The activity information includes a visiting frequency at an area, a visiting time at an area or a staying time in an area. The preference information includes the thing that the user is interested in. In an embodiment, the user information is obtained from social network, such as Facebook, twitter or Instagram, or a third-party sever.

In an embodiment, the advertisement information 213 is classified by the selecting module 221 according to the user information. For example, the advertisement information 213 related to sport equipment, menswear or 3C product is classified as a male advertising category. The advertisement information 213 related to skin care product, woman's clothing, or cosmetic is classified as a woman advertising category. As a result, when a gender of the personal basic data in the user information is male, the advertisement information 213 belonging to the male advertising category is selected from the advertisement information 213 to be regarded as the target advertisement information. Then, the target advertisement information is output to the electronic device 1.

Please refer to FIG. 2 and FIG. 3, in an embodiment, when the device location coordinate P2 of the electronic device 1 is in the overlapping region 212abc, the advertisement information 213a, 213b, 213c regarding to the overlapping region 212abc is output to the electronic device 1 by the server 2. The advertisement information 213a, 213b, 213c are displayed simultaneously on the display 14 for the user to select. As shown in FIG. 3, icons respectively corresponding to brand logo of the advertisement information 213a, 213b, 213c are displayed on the display 14, which is not limited herein.

Please refer to FIG. 3, in an embodiment, when the device location coordinate P2 of the electronic device 1 in the overlapping region 212abc, the advertisement information 213a, 213b, 213c regarding to the overlapping region 212abc are output to the electronic device 1 by the server 2. The advertisement information 213a regarding to the advertisement push region 212a corresponding to the push location 211a nearest to the device location coordinate P2 is displayed automatically on the display 14 by the second processor 12 of the electronic device 1, which is not limited herein.

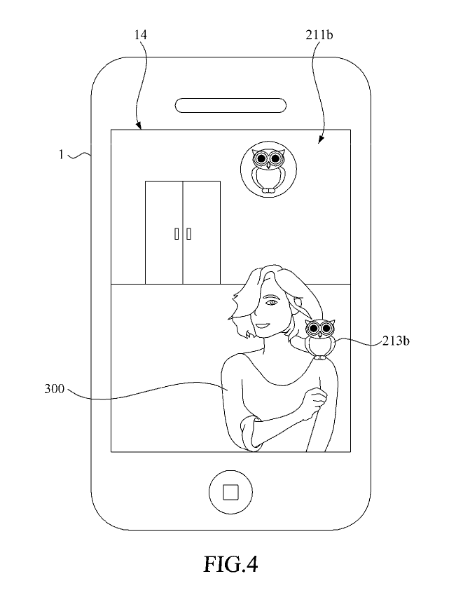

Please refer to FIG. 4, in an embodiment, when the user 300 selects the advertisement information 213b and takes a photo via the electronic device 1, the electronic device 1 combines the advertisement information 213b and a real-time reality image captured by the image capturing module 13 to an expanding reality information. Then, the expanding reality information is displayed on the display 14, which is shown in FIG. 4.

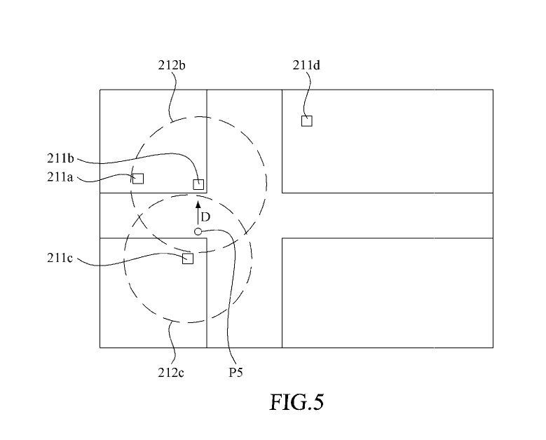

Please refer to FIG. 5, in an embodiment, when a device location coordinate P5 is in an overlapping region 212bc of the advertisement push region 212b and the advertisement push region 212c, and the advertisement information 213 regarding to the overlapping region 212bc is output to the electronic device 1 by the server 2, the advertisement information to be displayed on the display 14 is selected by the second selecting module 121 of the second processor 12 according to an orientation D of the image capturing module 13. For example, the orientation D that the image capturing module 13 facing toward is closer to the push location 211b. As a result, even if the advertisement information 213 regarding to the overlapping region 212bc which is output to the electronic device 1 by the server 2 includes the advertisement information 213b regarding to the advertisement push region 212b and the advertisement information 213c regarding to the advertisement push region 212c, the second selecting module 121 selects the advertisement information 213b regarding to the advertisement push region 212b to be displayed on the display 14 according to the orientation D

In an embodiment, the orientation D is a direction that the electronic device 1 facing toward is defined according to a movement direction of device location coordinate, or a sensing result sensed by an acceleration sensor and a gyroscope built-in the electronic device 1.

In sum, in the advertisement push system, a device location coordinate is generated by positioning the mobile device via a positioning module. The advertisement information to be pushed is determined according to the advertisement push region of the device location coordinate. Then, the expanding reality information is generated by combining the advertisement information and the real-time reality image and displayed via the display of the electronic device. As a result, an interactive effect between the user and the advertisement content is improved.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. An advertisement push system, comprising:
a processor configured to execute steps of:
receiving a device location coordinate of an electronic device; and
outputting advertisement information regarding to at least one of advertisement push regions corresponding to the device location coordinate to the electronic device when the device location coordinate is determined to be located in the advertisement push region.

2. The advertisement push system according to claim 1, wherein the advertisement push regions include at least one overlapping region, and after receiving the device location coordinate of an electronic device, the processor is configured to execute:
outputting the advertisement information regarding to the overlapping region when the device location coordinate is determined to be located in the overlapping region.

3. The advertisement push system according to claim 2, wherein in the step of outputting the advertisement information regarding to the overlapping region when the device location coordinate is determined to be located in the overlapping region, the processor is further configured to execute:
selecting at least one target advertisement information from the advertisement information regarding to the overlapping region according to at least one selecting condition before outputting the advertisement information of the overlapping region; and
outputting the target advertisement information.

4. A server, conducted to an advertisement push system, the server comprising:
an advertisement push database storing a plurality of push locations, advertisement push regions regarding to each push location, and advertisement information to be pushed according to the advertisement push regions; and
a processor connected with the advertisement push database;
wherein the server outputs advertisement information regarding to one of the advertisement push regions corresponding to a device location coordinate when the server receives the device location coordinate from an electronic device and the processor determines that the device location coordinate is located in the advertisement push region.

5. The server according to claim 4, wherein the advertisement push regions further include at least one overlapping region, when the processor determines that the device location coordinate is located in the overlapping region after receiving the device location coordinate of an electronic device, the server outputs the advertisement information regarding to the overlapping region.

6. The server according to claim 5, wherein the processor further includes a selecting module, the selecting module selects at least one target advertisement from the advertisement information regarding to the overlapping region according to at least one selecting condition before the server outputs the advertisement information of the overlapping region, and then the servers outputs the target advertisement information.

7. The server according to claim 6, wherein the selecting condition includes user information.

8. An electronic device, applied to an advertisement push system with a server, the electronic device comprising:
a positioning module configured to position a location of the electronic device to generate a device location coordinate;
a second processor connected with the positioning module, the second processor is configured to receive the device location coordinate;
a transmission module connected with the second processor, the transmission module is configured to output the device location coordinate;
an image capturing module connected to the processor, the image capturing module is configured to capture a real-time image; and
a display connected to the second processor;
wherein after the transmission module outputs the device location coordinate to the server, the electronic device receives the advertisement information corresponding to the device location coordinate from the server.

9. The electronic device according to claim 8, wherein the second processor further includes a second selecting module, the second selecting module determines whether the advertisement information is displayed on the display according to a selecting setting or an orientation that the image capturing module faces toward.

10. The electronic device according to claim 9, wherein the electronic device further includes a storage module, and the storage stores the selecting settings.
